(19) United States
(12) Patent Application Publication
(10) Pub. No.: US 2021/0097586 A1
(43) Pub. Date: Apr. 1, 2021

(54) SYSTEM AND METHOD FOR SOLO TRAVEL PLANNING

(71) Applicant: Elizabeth Smith Avery, Washington, DC (US)

(72) Inventor: Elizabeth Smith Avery, Washington, DC (US)

(21) Appl. No.: 17/247,453

(22) Filed: Dec. 11, 2020

Related U.S. Application Data
(63) Continuation-in-part of application No. 15/998,694, filed on Aug. 16, 2018.

(51) Int. Cl. G06Q 30/02; G06Q 30/06; G06Q 50/14

(52) U.S. Cl. CPC G06Q 30/0283; G06Q 10/025; G06Q 50/14; G06Q 30/0643

(57) ABSTRACT

A system and method for solo travel planning through searching input criteria of a customized search based on solo-pricing options, identifying solo travel services providing optimal solo-pricing options, and comparing the solo-pricing options based on different features of the customized search.

### CROSS-REFERENCE TO RELATED APPLICATION

This application claims the benefit of priority of U.S. non-provisional application Ser. No. 15/998,694, filed 16Aug. 2018, as a continuation-in-part thereof, the contents of which are herein incorporated by reference.

### BACKGROUND OF THE INVENTION

The present invention relates to travel planning and, more particularly, a system and method for solo travel planning through searching input criteria of a customized search based on solo-pricing options, identifying solo travel services providing solo-pricing options, and comparing the solo-pricing options based on different features of the customized search.

Existing travel search engines when queried by destination, tour type, or other travel-related accommodations or services reflect pricing biases skewed against solo travelers. The problem is that such queries commingle solo-traveler and multiple-traveler results, which are too undifferentiated to provide solo travelers with useful information in such an ocean of results. Existing search engines and online solo travel resources do not provide an effective solution as to best pricing options for solo travelers wanting to book travel services. Current travel-related search results either are devoid of solo pricing data or provide solo pricing options in a fragmented or ineffective manner.

The current norm in the travel industry is pricing for ‘doubles’, or in other words pricing for two individuals traveling together. Each industry has their own terminology, for instance in the lodging industry the pricing quote is referred to as the rack rate. In cruises and tours couples pay a lower per-person rate since solo travelers are often if not typically charged a “single supplement” penalty. The inventor calls that “one for the price of two”. For example, for a trip to China, a single individual may pay a 50% single supplement, totaling to $7,500 while two individuals booking together as a double only paid $5,000 each. Worse yet, couples/pairs/doubles may be given an even cheaper rate of $2,500 each if they booked early. In this case, the solo per-person rate is three times that of the double per person rate.

Currently there is no workable tool that provides individual travelers with a means to find and directly link to solo-traveler pricing options, identified as such; for instance, lodging that is priced for one traveler/one room as opposed to pricing conforming to double/one room. A specific example would be, if one were to currently search Google™ for “safari” “Africa” “no single supplement”, the user would be confronted with about 2,130,000 results. Not only is that too large a sampling to be useful, these search results also miss one of the key elements the present invention provides: a means of comparing whether a single supplement is waived, low or obviated by shared matching by the provider through a proprietary database.

As can be seen, there is a need for a system and method for solo travel planning through searching input criteria of a customized search based on solo-pricing options, identifying solo travel services providing solo-pricing options, and comparing the solo-pricing options based on different features of the customized search.The present invention, colloquially known as “Solo Travel Pricing Tracker™”, affords individual travelers a user-friendly interface for connecting with travel service providers (e.g., cruises, tours and the like) and related booking engines or databases, wherein one or more solo-priced options, such as: 1. No single supplement; 2. Lower single supplement (estimated at 25%-30% or preferably less than 20%); and 3. Sharing with a fellow solo traveler (to avoid a single supplement) are identified and compared based on different features of the customized search.

As explained above, currently there is no effective, uniform user-readable travel itinerary booking system adapted to search input criteria based on solo-pricing options, and so users of the current computer search tools are not able to compare between different solo-pricing options based on their search criteria. The present invention enables an apples-to-apples comparison of solo travelers pricing options based on different features of their customized search.

### SUMMARY OF THE INVENTION

In one aspect of the present invention, a method for comparing solo-pricing options provided through online travel providers and reservation booking systems, the method includes the following: a processor, a local data store, an availability engine, and a communication interface to communicate with a plurality of remote data stores, to fulfill a travel features request, and correspondingly adapt search input criteria for searching at least one data store, comprising the steps of: said processor receiving a user request for a solo traveler itinerary from a requesting user computing device with a structured graphical user interface, said request encompassing feature options for a desired solo traveler itinerary; said matching module analyzing said requested solo traveler itinerary for at least one feature matching said feature option in a local data store, and determining said matching feature at least partially conforms to at least one of a plurality of solo-pricing options comprising no single supplement, a lower single supplement; or a sharing feature; and said processor generating for delivery to said requesting user computing device all determined conformant matching feature for selection, wherein the structured graphical user interface is operatively connected to dynamic tables for optional additive features to be analyzed by the matching module.

These and other features, aspects and advantages of the present invention will become better understood with reference to the following drawings, description and claims.

### BRIEF DESCRIPTION OF THE DRAWINGS

FIG. 1 is a flowchart of an exemplary embodiment of a matching module of the present invention; and

FIG. 2 is a flowchart of an exemplary embodiment of the matching module of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention relates to systems, methods and computer program products for feature-option searches of booking engines and travel providers, wherein the present invention provides a tool for comparing solo-pricing options. Aspects of the present invention allow customers to identify, via a user-customizable search, travel-related amenities and/or accommodations. In this sense, user-customizable means the customer can enter search inputs other than those provided in a check-box list or other predetermined list. Customers are presented with goods and services matching or related to their query items and are permitted to select and confirm desired feature options and book, reserve or purchase their selection, including the booking of an accommodation and/or a means of travel thereto, wherein the feature options contemplating comparing solo-pricing options.

According to one embodiment of the present invention, there is provided a system for identifying and booking solo-travel features from a hospitality/travel provider having a processor, a network interface coupled to a network, a feature database stored on a non-transitory computer readable medium, a non-transitory storage medium storing processor instructions and an interface coupling the processor, storage medium, feature database and network interface. The feature database contains feature options associating a bookable accommodation/travel provider. The processor instructions cause the processor to receive, over the network, arbitrary feature identity information for a bookable feature from a user device; search the feature database for a match, at least in part; transmit one or more accommodation/travel provider identities associated with the matches; receive an accommodation/travel provider selection from the user device; and transmit for display on the user device an offer to the user to book a feature based on the user-customizable feature option information and/or the selected accommodation/travel provider.

Specifically, a user device may select among a series of trip, lodging or tour types by activities or interests and the present invention will identify all travel providers and their URL's that are responsive to the correlated feature options selected by the user. The software embodied in the present invention allows the user to identify and access travel providers for desired destinations correlated with activities and interests and further correlated with the level and method of pricing for solo travelers, thereby proving a method for users to identify optimal solo-pricing options (and thus avoid penalties or reduce surcharges) by accessing a proprietary database utilizing the intersection of destinations, type of trip/lodging, features, and solo-pricing categories. It is understood that travel providers include tour operators, lodgings, and the like. As a result, the present invention is computer-implemented solution to an inherent computer-Internet problem, whereby the present invention improves the efficacy of online travel-related searches for those traveling by themselves.

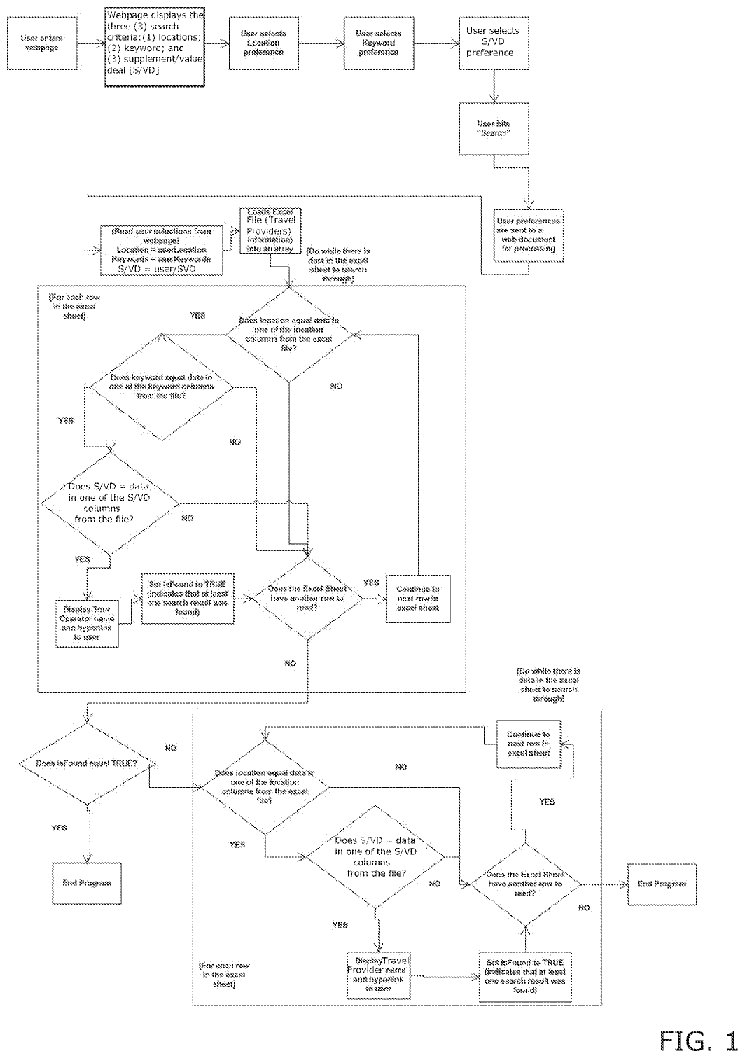

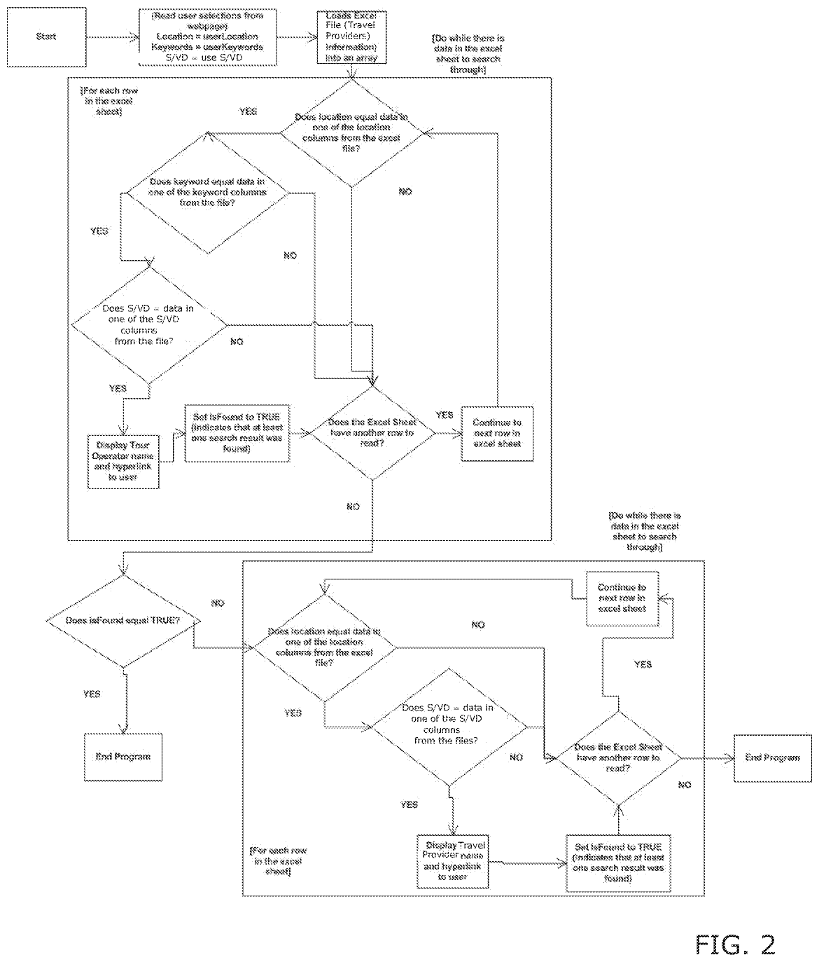

Referring now to FIGS. 1 through 2, the present invention may include system and method for solo travel planning through searching input criteria of a customized search based on solo-pricing options, identifying solo travel services providing solo-pricing options, and comparing the solo-pricing options based on different features of the customized search.

The systematic components embodied by the present invention include a structured user interface with a plurality of feature tabs for searching through the travel industry databases, whereby users can, for example, decide a region of the world where they would like to travel via a drop-down menu or other methodology. Users can select, via the user interface of their user device, among multiple types of travel again via drop-down menu or other methodologies. The user interface may also provide a drop-down menu or other methodology for the user to select among the rankings or systems of solo travel pricing. The user interface may be adapted to represent listings of providers that match the destination, type of trip/lodging, features and solo travel pricing methodology of their customizable search, thereby the system can compare among different options based on their search criteria and as a function of the features selected therein.

All the systemic components are interrelated and prompt a user to input criteria for searching at least one database, wherein a plurality of input criteria allows the user to craft a customized search. The user interface may be operatively connected to dynamic tables, such as GoogleTM sheets. The user interface is adaptable to become a social network and facilitate communication between different groups formed based on search criteria.

Additional system components include a feature of the user login in which user can keep a note of their own data and their own image. The user interface may be adapted to add new travel itinerary date such as preferred places, hotels, and tour operators so that a user can make the search completely customized based on the user's requirements. The user interface tool may be divided into two sections—e.g., hotels and tour operators. Under these sections, a user can make a search completely based the user's requirement.

Importantly, apart from the search results one can make a comparison among different hotels and tour operators and can see their details depending on various categories, features or requirements. There is also be a feature to register and receive the latest update related any queries, category, feature, requirements of the like.

The schematic block diagrams of FIGS. 1 and 2 embody (though not shown) an exemplary server and exemplary user device, wherein the server and user device include respective processors and memory and storage media, both of which are coupled to local interfaces. The local interface may comprise, for example, a data bus with an accompanying address/control bus or other bus structure as can be appreciated. The user device may also include a display coupled to the local interface to allow the processor to apply visual data to the display, such as a user interface generated by the user application. Display may be a holographic display, super imposed display image or augmented reality display. In some embodiments, the server and/or user device can include other elements that are coupled to their respective local interfaces such as a location system configured to obtain location, proximity or position data and other systems as can be appreciated. In addition, the user device may include user input such as a touchscreen, keyboard, toggles, mouse, push buttons, stylus or the like. Server and user device further include a network interface, coupled to local interface adapted to allow server and the user device to communicate with each other and other network resources through, for example, network which may be the internet, an intranet or other network system. Network interface may employ a protocol such as TCP/IP and may communicate on a medium such as Wi-Fi, wired Ethernet or other network media.

Stored in the respective memories may be several components that are executable by the processor(s). Stored in the memory of the server are a matching module, affiliate profile administrator module, payment module, and database. Stored in the memory of the user device may be the user application and other data and applications. It is understood that there may be other applications that are stored in the memories and are executable by the respective processors. Where any component discussed herein is implemented in the form of software, it may be in the respective machine code of processor or based upon a source programming language such as, for example, C, C++, Java, Java Script, Perl, PHP, Python, Flash, and/or other programming languages.

A plurality of software components are stored in the respective memories and are executable by the respective processors. In this respect, the term “executable” means a program file that is in a form that can ultimately be run by the processors. Examples of executable programs may be, for example, a compiled program that can be translated into machine code in a format that can be loaded into a random access portion of the memory and run by a respective processor, source code that may be expressed in proper format such as object code that is capable of being loaded into a random access portion of the memory and executed by a processor or source code that may be interpreted by another executable program to generate instructions in a random access portion of the memory to be executed by a processor , etc. An executable program may be stored in any portion or component of the memory including, for example, random access memory (RAM), read-only memory (ROM), hard drive, solid-state drive, USB flash drive, memory card, optical disc such as compact disc (CD) or digital versatile disc (DVD), floppy disk, magnetic tape, digital tables retrievable via a device or other memory components.

The memory may be defined herein as both volatile and nonvolatile memory and data storage components. Volatile components are those that do not retain data values upon loss of power. Nonvolatile components are those that retain data upon a loss of power. Thus, the memory may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, digital tables retrievable via a device and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device. Although described herein as a single memory and a single processor, it should be recognized that both distributed memory and distributed processing are encompassed in the present invention. Such distributed memory may be distributed in any of several known ways, such as but not limited to be distributed by type of data or distributed across a plurality of databases housed in different locations. Similarly, distributed processing includes any of several known ways including but not limited to processor arrays and a plurality of different processors located in different locations performing different types of functions.

In addition, the processor may represent multiple processors and the memory may represent multiple memories that operate in parallel. In such a case, the local interface may be an appropriate network that facilitates communication between any two of the multiple processors, between any processor and any one of the memories, or between any two of the memories etc. The local interface may comprise additional systems designed to coordinate this communication, including, for example, performing load balancing. The processor may be of electronic or of some other available construction.

Although various systems and applications mentioned above may be depicted as being embodied in software or code executed by general purpose hardware such as processor-based systems as discussed above, as an alternative the same may also be embodied in dedicated hardware or a combination of software/general purpose hardware and dedicated hardware. If embodied in dedicated hardware, such systems and applications can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable circuits such as field programmable gate arrays (FPGAs) or other components, etc.

Although the flowcharts of FIGS. 1 and 2 show a specific order of execution, it is understood that the order of execution may differ from that which is depicted. For example, the order of execution of two or more blocks may be scrambled relative to the order shown. Also, two or more blocks shown in succession may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, where various systems and applications described herein comprise software or code, each can be embodied in any tangible, non-transitory computer-readable medium for use by or in connection with an instruction execution system such as, for example, a processor in a computer system or other system. In this sense, such systems or applications may comprise, for example, statements including instructions and declarations that can be fetched from the computer-readable medium and executed by the instruction execution system. In the context of the present disclosure, a “computer-readable medium” can be any tangible, non-transitory medium that can contain, store, or maintain the above-described systems and applications for use by or in connection with the instruction execution system. The computer readable medium can comprise any one of many physical media such as, for example, electronic, magnetic, optical, or semiconductor media. More specific examples of a suitable computer-readable medium would include, but are not limited to, magnetic tapes, magnetic floppy diskettes, magnetic hard drives, memory cards, solid-state drives, Universal Serial Bus (USB) flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be understood, of course, that the foregoing relates to exemplary embodiments of the invention and that modifications may be made without departing from the spirit and scope of the invention as set forth in the following claims.

What is claimed is:

1. A method for comparing solo-pricing options provided through online travel providers and reservation booking systems, the method comprising:
a processor, a local data store, an availability engine, and a communication interface to communicate with a plurality of remote data stores, to fulfill a travel features request, and correspondingly adapt search input criteria for searching at least one data store, comprising the steps of:
said processor receiving a user request for a solo traveler itinerary from a requesting user computing device with a structured graphical user interface, said request encompassing feature options for a desired solo traveler itinerary;
said matching module analyzing said requested solo traveler itinerary for at least one feature matching said feature option in a local data store, and determining said matching feature at least partially conforms to at least one of a plurality of solo-pricing options comprising no single supplement, a lower single supplement; or a sharing feature; and
said processor generating for delivery to said requesting user computing device all determined conformant matching feature for selection.

2. The method of claim 1, wherein the structured graphical user interface is operatively connected to dynamic tables for optional additive features to be analyzed by the matching module.
